(19) United States
(12) Patent Application Publication
(10) Pub. No.: US 2023/0385371 A1
(43) Pub. Date: Nov. 30, 2023

(54) METHOD AND APPARATUS FOR PERFORMING CORRELATION COMPUTATION WITH REDUCED COMPLEXITY THROUGH USING COMPOSITE CODE SEQUENCE THAT IS GENERATED FROM PERFORMING BIT-WISE COMBINATION WITH TRANSFORMATION UPON MULTIPLE CODE SEQUENCES

(71) Applicant: MEDIATEK INC., Hsin-Chu (TW)

(72) Inventor: Kun-Tso Chen, Hsinchu City (TW)

(73) Assignee: MEDIATEK INC., Hsin-Chu (TW)

(21) Appl. No.: 18/142,568

(22) Filed: May 2, 2023

Related U.S. Application Data
(60) Provisional application No. 63/345,053, filed on May 24, 2022.

(51) Int. Cl. G06F 17/15; G01S 19/30

(52) U.S. Cl. CPC G06F 17/15; G01S 19/30

(57) ABSTRACT

A correlation computation method includes: obtaining a plurality of code sequences; performing, by a transformation circuit, a bit-wise combination with transformation upon the plurality of code sequences to generate a composite code sequence; and generating a correlation value between a data sequence and the composite code sequence.

### CROSS REFERENCE TO RELATED APPLICATIONS

This application claims the benefit of U.S. Provisional Application No. 63/345,053, filed on May 24, 2022. The content of the application is incorporated herein by reference.

### BACKGROUND

The present invention relates to correlation computation, and more particularly, to a method and apparatus for performing correlation computation with reduced complexity through using a composite code sequence that is generated from performing a bit-wise combination with transformation upon multiple code sequences.

The global navigation satellite system (GNSS) is often described as an “invisible utility” and is so effective at delivering two essential services—time and position—accurately, reliably and cheaply that many aspects of the modern world have become dependent upon them. Each satellite of the GNSS is equipped with a highly precise atomic clock. When four or more satellites are in view, a GNSS receiver can measure the distance to each satellite by estimating the signal transmission time delay from the satellite to the receiver. From these measurements, a GNSS-embedded device can derive its own position and synchronize to the accurate GNSS system time.

A GNSS satellite signal is modulated by pseudo random noise (PRN) code. The PRN code is a code sequence with randomly distributed 0's and 1's. Each satellite transmits a unique PRN code. The GNSS receiver identifies any of the satellites by its unique PRN code. The unique PRN code is continuously repeated. The GNSS receiver uses a local replica version of the satellite signal to correlate the received satellite signal. The purpose of the correlation process is to synchronize the timing between the local replica and the received satellite signal. Because the timing is unknown and dynamic, the received satellite PRN code sequence must be correlated with a plurality of its time-shifted versions. If the satellite PRN code sequence is unknown, the receiver must try all the possible sequences.

Many correlation hypotheses are required by a GNSS receiver to search the satellite (i.e., match the satellite PRN code), where each hypothesis requires a correlation operation between a local code sequence {D_{h,n}, n=0, 1, . . . , N−1} and a received data sequence {rₙ, n=0, 1, . . . , N−1} to generate a correlation result Tₕ for h=0, 1, . . . , H-1. For example, many hypotheses (H=20460) are required to search a GPS L5 signal in a cold start condition. Moreover, there are many satellites to be acquired in a modern GNSS receiver. Thus, there is a need for an innovative correlator architecture that is capable of acquiring multiple satellites at the same time with reduced computation complexity.

### SUMMARY

One of the objectives of the claimed invention is to provide a method and apparatus for performing correlation computation with reduced complexity through using a composite code sequence that is generated from performing a bit-wise combination with transformation upon multiple code sequences.

According to a first aspect of the present invention, an exemplary correlation computation method is disclosed. The exemplary correlation computation method includes: obtaining a plurality of code sequences; performing, by a transformation circuit, a bit-wise combination with transformation upon the plurality of code sequences to generate a composite code sequence; and generating a correlation value between a data sequence and the composite code sequence.

According to a second aspect of the present invention, an exemplary correlation computation apparatus is disclosed. The exemplary correlation computation apparatus includes a transformation circuit and a correlation circuit. The transformation circuit is arranged to obtain a plurality of code sequences, and perform a bit-wise combination with transformation upon the plurality of code sequences to generate a composite code sequence. The correlation circuit is arranged to generate a correlation value between a data sequence and the composite code sequence.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a correlation computation apparatus according to an embodiment of the present invention.

FIG. 2 is a diagram illustrating a first design of the correlation computation apparatus shown in FIG. 1 according to an embodiment of the present invention.

FIG. 3 is a diagram illustrating a second design of the correlation computation apparatus shown in FIG. 1 according to an embodiment of the present invention.

FIG. 4 is a diagram illustrating a first correlation circuit design with reduced computation complexity according to an embodiment of the present invention.

FIG. 5 is a diagram illustrating a second correlation circuit design with reduced computation complexity according to an embodiment of the present invention.

FIG. 6 is a diagram illustrating a first GNSS receiver architecture according to an embodiment of the present invention.

FIG. 7 is a diagram illustrating a second GNSS receiver architecture according to an embodiment of the present invention.

FIG. 8 is a diagram illustrating a third GNSS receiver architecture according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

To search PRN codes of several satellite signals at the same time, a GNSS receiver design may use a local composite code sequence {D_{h,n}=C⁽¹⁾_{h,n}+ . . . +^{(p)}_{h,n}} to correlate with the received data sequence {rₙ}, where the local composite code sequence {D_{h,n}} is a direct sum of P candidate PRN code sequences. The value of PRN code bit is binary in GNSS. That is, C^{(p)}_{h,n} is equal to 1 or −1. Since each code bit of the local composite code sequence {D_{h,n}} is not a binary value anymore, the correlation operation {D_{h,n}}·{rₙ} is more complex than {C_{h,n}}·{rₙ}. In addition, the multiplication and addition/subtraction operation during the correlation process must be reduced to save the power. To address these issues, the present invention proposes an innovative correlator architecture that is capable of acquiring multiple satellites at the same time with reduced computation complexity. Further details are described as below with reference to the accompanying drawings.

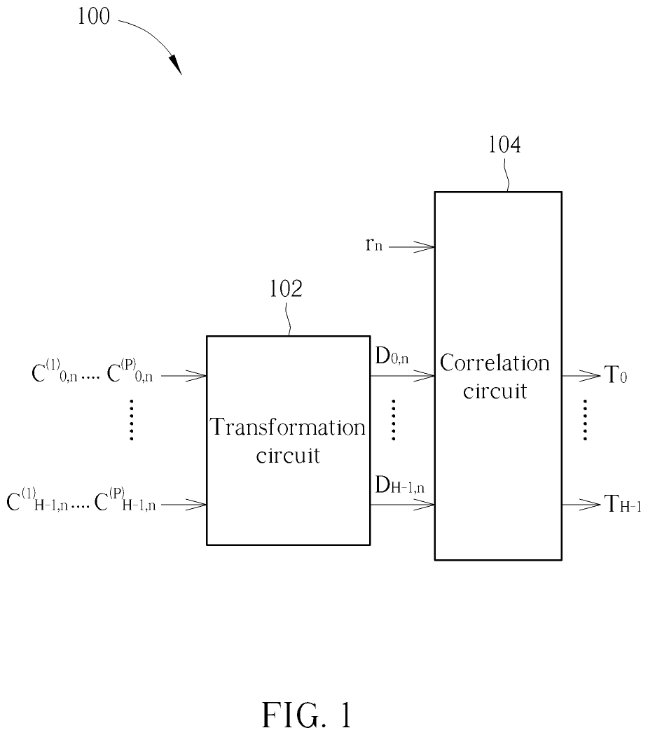

FIG. 1 is a diagram illustrating a correlation computation apparatus according to an embodiment of the present invention. By way of example, but not limitation, the correlation computation apparatus 100 maybe a part of a multi-satellite correlator in a GNSS receiver that can search PRN codes of several satellite signals at the same time. In practice, any application using the proposed correlation computation apparatus 100 to deal with computation of correlation values falls within the scope of the present invention. In this embodiment, the correlation computation apparatus 100 includes a transformation circuit 102 and a correlation circuit 104. It should be noted that only the components pertinent to the present invention are illustrated in FIG. 1. In practice, the correlation computation apparatus 100 may include additional components for other designated functions. In one exemplary design, the correlation computation apparatus 100 may be implemented using dedicated hardware that is designed to perform the proposed correlation computation method. In another exemplary design, the correlation computation apparatus 100 maybe implemented using a general-purpose processor that loads and executes program codes to perform the proposed correlation computation method. In yet another exemplary design, the correlation computation apparatus 100 maybe implemented using any combination of hardware and software. To put it simply, any correlation computation design using the proposed computation complexity reduction technique falls within the scope of the present invention.

The transformation circuit 102 is arranged to obtain a plurality of code sequences C⁽¹⁾_{h,n}, . . . , C^{(p)}_{h,n} for each hypothesis correlation Corₕ (h={0, 1, . . . , H−1}), where the code sequences C⁽¹⁾_{h,n}, . . . , C^{(p)}_{h,n} are unique PRN codes of P satellites to be acquired, and each of the code sequences C⁽¹⁾_{h,n}, . . . , C^{(p)}_{h,n} includes N code bits Cₙ (n={0, 1, . . . , N−1}). For each hypothesis correlation Corₕ (h={0, 1, . . . , H−1}), the transformation circuit 102 is further arranged to perform a bit-wise combination with transformation upon the code sequences C⁽¹⁾_{h,n}, . . . , C^{(p)}_{h,n} to generate a composite code sequence D_{h,n}. For each hypothesis correlation Corₕ (h={0, 1, . . . , H−1}), the correlation circuit 104 is arranged to generate a correlation value Tₕ between a data sequence rₙ{rₙ, n=0, 1, . . . , N−} and the composite code sequence D_{h,n}. For example, the data sequence rₙ is a data block of N (N>1) received data samples {rₙ, n=0, . . . , N−1} output from an analog-to-digital converter (ADC). The ADC can capture one sample of the received signal per PRN code bit. Or several samples per PRN code bit are captured by the ADC and are processed further to get a data sample per PRN code bit. On the other hand, the samples per PRN code bit can be used to correlate with the corresponding samples of a local PRN code bit. Other signal processing might be applied before correlation, such as carrier frequency or Doppler frequency removal. In order to describe our invention more clearly, the following embodiments use one sample per PRN code bit and without other signal processing.

Each of the code sequences C⁽¹⁾_{h,n}, . . . , C^{(P)}_{h,n} is paired with the data sequence rₙ for correlation computation, and thus includes N codes bits (also called chips due to bearing no useful data information) at different bit positions n {n=0, 1, . . . , N−1}, respectively. In this embodiment, the transformation circuit 102 may obtain a preliminary composite code sequence (which may be regarded as a sum code sequence) D′_{h,n}by a direct sum of the code sequences C⁽¹⁾_{h,n}, . . . , C^{(P)}_{h,n} (i.e., D′_{h,n}=C⁽¹⁾_{h,n}+ . . . +C^{(P)}_{h,n}, where each composite code bit at a bit position in the preliminary composite code sequence D′_{h,n} is obtained from a sum of a plurality of code bits at the same bit position in the code sequences C⁽¹⁾_{h,n}, . . . , C^{(P)}_{h,n}; and then apply a predetermined transformation to the preliminary composite code sequence D′_{h,n} (particularly, each composite code bit of the preliminary composite code sequence D′_{h,n} for generating the final composite code sequence D′_{h,n} that is actually used to correlate with the data sequence rₙ. Based on the predetermined transformation employed by the transformation circuit 102, different values (e.g., non-zero values) possessed by composite code bits at different bit positions in the preliminary composite code sequence D′_{h,n} may be transformed to the same value (e.g., zero value). The correlation circuit 104 can benefit from such characteristics resulting from code bit transformation to achieve computation complexity reduction. For example, when a specific code bit in the composite code sequence D_{h,n} has a zero value, the correlation circuit 104 may skip correlation between the specific code bit and a specific data sample included in the data sequence rₙ that is paired with the specific code bit.

In some embodiments of the present invention, the bit-wise combination with transformation employed by the transformation circuit 102 may use ternary code transformation or binary code transformation. For example, the predetermined transformation applied to the preliminary composite code sequence D′_{h,n} (particularly, each code bit of the preliminary composite code sequence D′_{h,n} ) may be ternary code transformation or binary code transformation. In other words, the final composite code sequence D′_{h,n} output from the transformation circuit 102 may be regarded as a ternary code sequence or a binary code sequence that is derived from a sum code sequence. Supposing that PRN code sequences of four satellites are represented by C⁽³⁾, C⁽²⁾, C⁽¹⁾ and C⁽⁰⁾. Some examples of sum code sequences, ternary code sequences and binary code sequences are illustrated in the following table.

TABLE 1

| Satellite PRN code | | | | Sum Code | | | Ternary Code | | | Binary Code | |
|---|---|---|---|---|---|---|---|---|---|---|---|
| C⁽³⁾ | C⁽²⁾ | C⁽¹⁾ | C⁽⁰⁾ | D4 | D3 | D2 | D4 | D3 | D2 | D5 | D3 |
| 1 | 1 | 1 | 1 | 4 | 3 | 2 | 1 | 1 | 1 | 1 | 1 |
| 1 | 1 | 1 | −1 | 2 | 1 | 0 | 1 | 0 | 0 | 1 | 1 |
| 1 | 1 | −1 | 1 | 2 | 1 | 0 | 1 | 0 | 0 | 1 | 1 |
| 1 | 1 | −1 | −1 | 0 | −1 | 2 | 0 | 0 | −1 | 1 | −1 |
| 1 | −1 | 1 | 1 | 2 | 1 | | 1 | 0 | | 1 | 1 |
| 1 | −1 | 1 | −1 | 0 | −1 | | 0 | 0 | | 1 | −1 |
| 1 | −1 | −1 | 1 | 0 | −1 | | 0 | 0 | | 1 | −1 |
| 1 | −1 | −1 | −1 | −2 | 3 | | −1 | −1 | | −1 | −1 |
| −1 | 1 | 1 | 1 | 2 | | | 1 | | | 1 | |
| −1 | 1 | 1 | −1 | 0 | | | 0 | | | 1 | |
| −1 | 1 | −1 | 1 | 0 | | | 0 | | | 1 | |
| −1 | 1 | −1 | −1 | −2 | | | −1 | | | −1 | |
| −1 | −1 | 1 | 1 | 0 | | | 0 | | | 1 | |
| −1 | −1 | 1 | −1 | −2 | | | −1 | | | −1 | |
| −1 | −1 | −1 | 1 | −2 | | | −1 | | | −1 | |
| −1 | −1 | −1 | −1 | 4 | | | −1 | | | −1 | |

In the above table, a code sequence Di is obtained from i PRN code sequences. For example, the sum code sequence D4 is a direct sum of 4 PRN code sequences C⁽³⁾, C⁽²⁾, C⁽¹⁾ and C⁽⁰⁾The sum code sequence D3 is a direct sum of 3 PRN code sequences C⁽²⁾, C⁽¹⁾ and C⁽⁰⁾The sum code sequence D2 is a direct sum of 2 PRN code sequences C⁽¹⁾ and C⁽⁰⁾. A sum code sequence acts as the preliminary composite code sequence D′_{h,n} that is aforementioned. The final composite code sequence D_{h,n} aforementioned may be a ternary code sequence or a binary code sequence that is obtained from applying transformation to the sum code sequence. Preferably, binary code sequences (D3 and D5 for example) are available only for odd numbers of PRN code sequences.

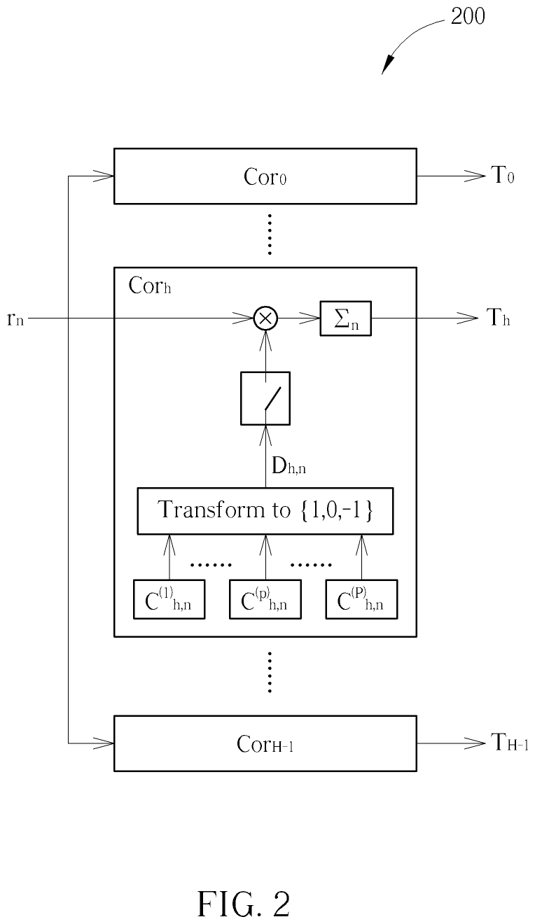

In a case where the bit-wise combination with transformation applied by the transformation circuit 102 uses ternary code transformation, the correlation computation apparatus 100 shown in FIG. 1 may be implemented using the correlation computation apparatus 200 shown in FIG. 2. For example, each code bit of the composite code sequence D_{h,n} (h={0, 1, . . . , H−1}) may belong to {1, 0, −1} based on the targeted PRN chips C⁽¹⁾_{h,n} , . . . , C^{(P)}_{h,n} , . . . , C^{(P)}_{h,n} . Regarding the hypothesis correlation Corₕ (h={0, 1, . . . , H−1}) , the correlation value Tₕ between the data sequence rₙ {rₙ, n=0, 1, . . . , N−1} and the corresponding composite code sequence D_{h,n} may be computed using the following formula.

Tₕ=Σₙ₌₀^{N-1}D_{h,n}·rₙ (1)

In this embodiment, when a specific code bit in the composite code sequence D_{h,n} has a zero value, the correlation circuit 104 may skip correlation between the specific code bit and a specific data sample included in the data sequence rₙ that is paired with the specific code bit. Hence, the above formula (1) can be reformulated as below.

$${T}_{h} = {\sum }_{n = 0}^{N - 1} {δ}_{{D}_{h , n}} \cdot {D}_{h , n} \cdot {r}_{n} , where {δ}_{{D}_{h , n}} = \{ \begin{matrix}0 , if {D}_{h , n} = 0 \\ 1 , if {D}_{h , n} \neq 0\end{matrix} \qquad ( 2 )$$

Since data samples in the data sequence rₙ that are paired with the corresponding zero code bits D_{h,n}=0 have no contribution to the correlation value Tₕ, the correlation circuit 104 is allowed to obtain the correlation value Tₕ by accumulating data samples paired with the corresponding non-zero code bits (D_{h,n}≠0) only. Since the number of data samples actually selected for computation of the correlation value Tₕ is small than the number of all data samples included in the data sequence rₙ (which is a data block of N data samples), the computation of the correlation value Tₕ has reduced complexity.

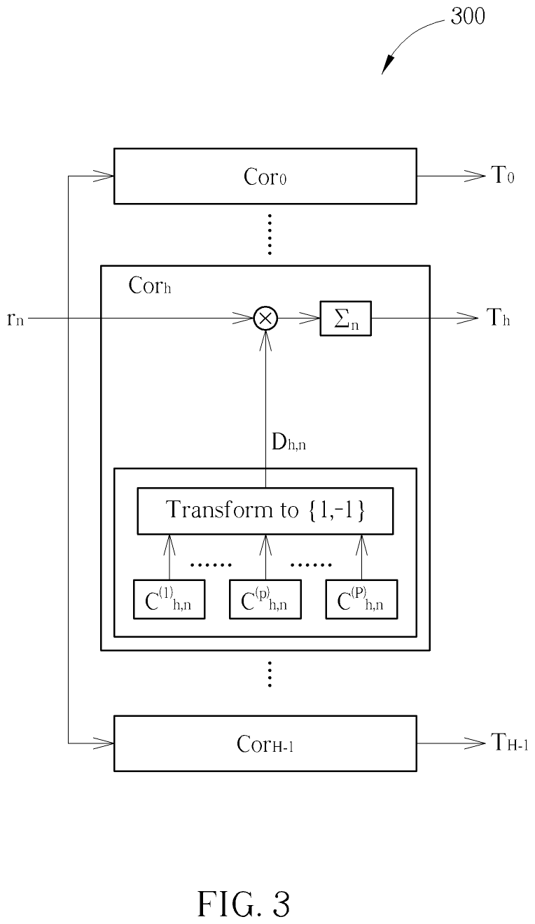

In another case where the bit-wise combination with transformation applied by the transformation circuit 102 uses binary code transformation, the correlation computation apparatus 100 shown in FIG. 1 may be implemented using the correlation computation apparatus 300 shown in FIG. 3. For example, each code bit of the composite code sequence D_{h,n} (h={0, 1, . . . , H−1}) may belong to {1, −1} based on the targeted PRN chips C⁽¹⁾_{h,n}, . . . , C^{(p)}_{h,n}, . . . , and C^{(P)}_{h,n}. Since each code bit of the composite code sequence D_{h,n}(h={0, 1, . . . , H−1}) is selected from a group consisting of only two values, several complexity reduction techniques are applicable to such a correlator design using a transformed binary code sequence as the composite code sequence D_{h,n} to correlate with the received data sequence rₙ.

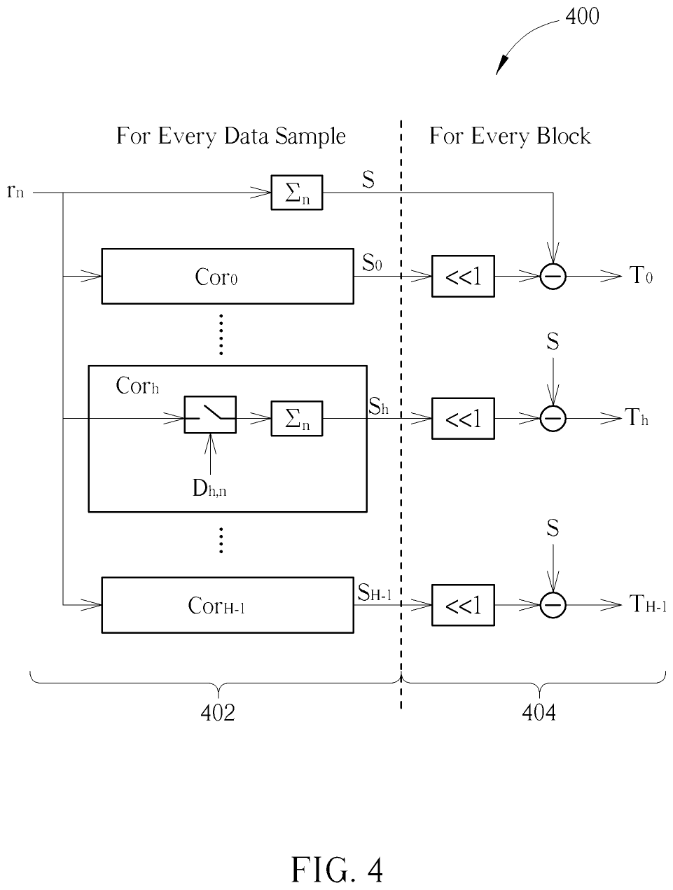

FIG. 4 is a diagram illustrating a first correlation circuit design with reduced computation complexity according to an embodiment of the present invention. The correlator circuit 104 shown in FIG. 1 may be implemented by the correlator circuit 400 shown in FIG. 4. The correlator circuit 400 includes an accumulation-based circuit 402 and a processing circuit 404. The accumulation-based circuit 402 is arranged to obtain a sum S of all data samples included in the data sequence rₙ (which is a data block of N (N>1) received data samples {rₙ, n=0, . . . , N−1}). Hence, the sum S can be expressed by the following formula.

S=Σₙ₌₀^{N-1}rₙ (3)

With regard to computation of the correlation value Tₕ (h={0, . . . , H−1 }) between the data sequence rₙ and the composite code sequence D_{h,n} generated from a transformation circuit (e.g., transformation circuit 102 shown in FIG. 1), the accumulation-based circuit 402 is further arranged to obtain a partial sum Sₕ of selected data samples that are selected from the data sequence rₙ according to code bits included in the composite code sequence D_{h,n}; and the processing circuit 404 is arranged to derive the correlation value Tₕ between the data sequence rₙ and the composite code sequence D_{h,n} from the sum S and the partial sum Sₕ.

For better comprehension of technical features of the proposed complexity reduction technique, the following assumes that a code bit with a value ‘1’ in the composite code sequence D_{h,n} (h={0, 1, . . . , H−1}) is mapped to 0, and a code bit with a value ‘−1’ in the composite code sequence D_{h,n} (h={0, 1, . . . , H−1}) is mapped to +1. Regarding the hypothesis correlation Corₕ, the correlation value Tₕ between the data sequence rₙ {rₙ, n=0, 1, . . . , N−1} and the composite code sequence D_{h,n} {Db,n, n=0, 1, . . . , N−1} may be computed using the following formula.

Tₕ=Σₙ₌₀^{N-1}(1−2·D_{h,n})·rₙ=Σₙ₌₀^{N-1}rₙ−2·Σₙ₌₀^{N-1}D_{h,n}·rₙ=S−2·Sₕ (4)

In the above formula (4), the partial sum Sₕ can be expressed by the following formula.

$${S}_{h} = {\sum }_{n = 0}^{N - 1} {δ}_{{D}_{h , n}} \cdot {r}_{n} , where {δ}_{{D}_{h , n}} = \{ \begin{matrix}0 , if {D}_{h , n} = 0 \\ 1 , if {D}_{h , n} = 1\end{matrix} \qquad ( 5 )$$

Since data samples in the data sequence rnthat are paired with the corresponding zero code bits D_{h,n}=0 have no contribution to the partial sum S_{b}, the accumulation-based circuit 402 is allowed to obtain the partial sum Sₕ by accumulating data samples paired with the corresponding non-zero code bits (D_{h,n}=1) only. Since the number of selected data samples selected from the data sequence rₙ (which is a data block of N data samples) for computation of the partial sum Sₕ is small than the number of all data samples included in the data sequence rₙ (which is a data block of N data samples), the computation of the partial sum Sₕ has reduced complexity.

In accordance with the above formula (4) , the processing circuit 404 obtains a multiplication result (i.e., 2·Sₕ) from multiplying the partial sum Sₕ by a predetermined factor (i.e., 2) , and then generates the correlation value Tₕ between the data sequence rₙ and the code sequence D_{h,n} by subtracting the multiplication result (i.e., 2·Sₕ) from the sum S of all data samples (i.e., S=Σₙ₌₀^{N-}rₙ). As shown in FIG. 4, the same sum S (i.e., S=Σₙ₌₀^{N-}rₙ) can be shared by all hypothesis correlations Cor₀-Cor_{H-1}. In this way, the computation of the correlation values T₀-T_{H-1} has reduced complexity.

As shown in FIG. 4, one bit-shifting circuit for multiplying the partial sum by the predetermined factor is required for computation of each correlation value Tₕ (h={0, . . . , H−1}) . With regard to the correlator design, what is concerned is the relative magnitude between the correlation values T₀-T_{H-1} rather than the absolute magnitude of each of the correlation values T₀-T_{H-1}. The processing circuit 404 shown in FIG. 4 can be modified to further reduce the computation complexity. For example, the computation of each correlation value Tₕ can be simplified by using the following formula.

$${T}_{h} = \frac{s - 2 \cdot {s}_{h}}{2} = \frac{s}{2} - {S}_{h} \qquad ( 6 )$$

Based on the above formula (6), the modified processing circuit 404 requires only a single bit-shifting circuit for generating a division result (i.e., S/2) that is shared by computation of all correlation values T₀-T_{H-1}.

Regarding the exemplary design shown in FIG. 4, partial sums S₀-S_{H-1} for different hypothesis correlations Cor₀-CorT_{H-1} are computed independently. It is possible that the composite code sequences D_{0,n}-D_{H-1,n} have the same bit pattern at consecutive bit positions. Hence, a partial sum derived from accumulating data sample(s) selected from a data word (partial data sequence) that is paired with the same bit pattern (partial code sequence) in multiple composite code sequences can be shared by computation of partial sums for multiple hypothesis correlations, thereby further reducing the computation complexity.

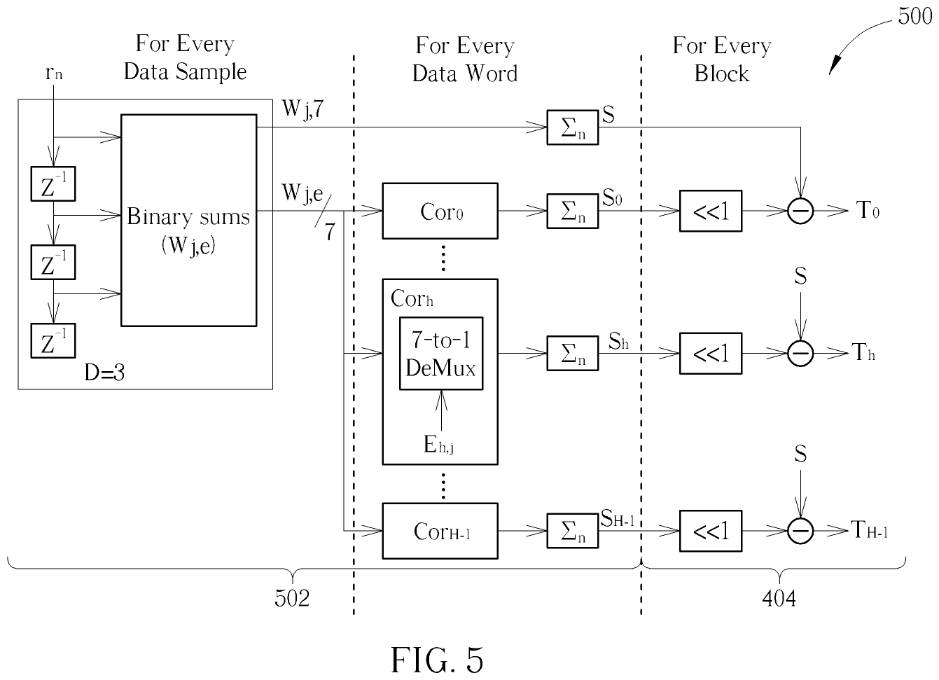

FIG. 5 is a diagram illustrating a second correlation circuit design with reduced computation complexity according to an embodiment of the present invention. The correlator circuit 104 shown in FIG. 1 may be implemented by the correlator circuit 500 shown in FIG. 5. The correlator circuit 500 includes an accumulation-based circuit 502 and the aforementioned processing circuit 404. The accumulation-based circuit 502 is arranged to categorize all data samples included in the data sequence r. into J (J>1) data words, each having D (D>1) consecutive data samples, where N=J·D; and is further arranged to categorize all code bits included in each composite code sequence D_{h,n} into J (J>1) code words E_{h,j} (j={0, . . . , J−1}), each having D (D>1) consecutive code bits. Note that we can also choose D and J so that N=J·D−k. That is, we can add k dummy bits to the data samples. For example, k one's are added to the tail of received and local code sequence, respectively. Regarding computation of the correlation value Tₕ for the hypothesis correlation Corₕ, the accumulation-based circuit 502 is arranged to accumulate J selected binary sums one by one to generate the partial sum Sₕ. For a specific data word (which consists of D consecutive data samples) being one of the J data words in the data sequence rₙ, the accumulation-based circuit 502 generates (2^{D}−1) binary sums W_{j,e} that are pre-computed sums obtained according to D data samples included in the specific data word, where e={1, . . . , 2^{D}−1}. After the (2^{D}−1) binary sums W_{j,e} are available, the accumulation-based circuit 502 refers to a specific code word E_{h,j} (which is one of the J code words in the code sequence D_{h,n} and paired with the specific data word) to select one of the (2^{D}−1) binary sums W_{j,e} as one of the J selected binary sums that are involved in computation of the partial sum Sₕ for the hypothesis correlation Corₕ.

Suppose that 3 (D=3) data samples in the data sequence rₙ is grouped as one data word. For each data word, the accumulation-based circuit 502 computes 7 binary sums W_{j,e}, each being a partial sum of the data word that is computed in a way similar to that specified in the formula (5), where e={1, 2, . . . , 7} and there are J data words per data sequence rₙ (which is a data block of N data samples). Suppose that 3 data samples grouped into the same data word are labeled by {Rₙ, Rₙ₋₁, Rₙ₋₂}, the binary sum W_{j,1} (W_{j,1}=Rₙ₋₂) is obtained from one data sample Rₙ₋₂that is selected from the data samples {Rₙ, Rₙ₋₁, Rₙ₋₂} according to code bits included in a code word “001” with a decimal value e=1, the binary sum W_{j,2} (W_{j,2}=Rₙ₋₁) is obtained from a selected data sample Rₙ₋₁ that is selected from the data samples {Rₙ, Rₙ₋₂} according to code bits included in a code word “010” with a decimal value e=2, the binary sum W_{j,3} (W_{j,3}=Rₙ₋₁+Rₙ₋₂) is obtained from two data samples Rₙ₋₁ and Rₙ₋₂that are selected from the data samples {Rₙ, Rₙ₋₁, Rₙ₋₂} according to code bits included in a code word “011” with a decimal value e=3, the binary sum W_{j,4} (W_{j,4}=Rₙ) is obtained from one data sample Rn that is selected from the data samples {Rₙ, Rₙ₋₂} according to code bits included in a code word “100” with a decimal value e=4, the binary sum W_{j,5} (W_{j,5}=Rn+Rₙ₋₂) is obtained from two data samples Rₙ and Rₙ₋₂that are selected from the data samples {Rₙ, Rₙ₋₁, Rₙ₋₂} according to code bits included in a code word “101” with a decimal value e=5, the binary sum W_{j,6} (W_{j,6}=Rn+Rₙ₋₁) is obtained from two data samples Rₙ and Rₙ₋ᵢ that are selected from the data samples {Rₙ, Rₙ₋₁, Rₙ₋₂} according to code bits included in a code word “110” with a decimal value e=6, and the binary sum W_{j,7} (W_{j,7}=Rn+Rₙ₋₁+Rₙ₋₂) is obtained from all data samples Rₙ, Rₙ₋₁, and Rₙ₋₂that are selected from the data samples {Rₙ, Rₙ₋₁, Rₙ₋₂} according to code bits included in a code word “111” with a decimal value e=7. It should be noted that, since partial sum accumulation is skipped for the code word “000”, no binary sum is pre-computed for the code word “000”.

In one exemplary implementation, the sum S of all data samples included in the data sequence rₙ can be computed using the above formula (3) . Alternatively, since the binary sum W_{j,7} (W_{j,7}=Rn+Rₙ₋₁+Rₙ₋₂) is pre-computed for each of the J data words, the sum S of all data samples included in the data sequence rₙ can be obtained from accumulating binary sums W_{j,7} pre-computed for J data words. Specifically, the above formula (3) may be reformulated as below.

S=Σₙ₌₀^{N-1}rₙ=Σⱼ₌₀^{j-1}W_{j,7} (7)

Since there are J data words in the data sequence rₙ {rₙ, n=0, . . . , N−1} and one of the pre-computed binary sums W_{j,e} (j={0, . . . , J−1}) is selected as a partial sum of each data word according to a corresponding code word E_{h,j} in a code sequence D_{h,n}, the partial sum Sₕ (h={0, . . . , H−1}) may be computed using the following formula.

$${S}_{h} = {\sum }_{j = 0}^{J - 1} {\sum }_{e = 1}^{7} {δ}_{{E}_{h , j}} = e \cdot {W}_{j , e} , where {δ}_{{E}_{h , j = e}} = \{ \begin{matrix}1 , if {E}_{h , j} = e \\ 0 , if {E}_{h , j} \neq e\end{matrix}$$

In other words, the binary sum W_{j,1} pre-computed for the current data word is selected and output for accumulation if the code word E_{h,j} corresponding to the current data word is “001”; the binary sum W_{j, 2} pre-computed for the current data word is selected and output for accumulation if the code word E_{h,j} corresponding to the current data word is “010”; the binary sum W_{j,3} pre-computed for the current data word is selected and output for accumulation if the code word E_{h,j} corresponding to the current data word is “011”; the binary sum W_{j,4} pre-computed for the current data word is selected and output for accumulation if the code word E_{h,j} corresponding to the current data word is “100”; the binary sum W_{j,5} pre-computed for the current data word is selected and output for accumulation if the code word E_{h,j} corresponding to the current data word is “101”; the binary sum W_{j,6} pre-computed for the current data word is selected and output for accumulation if the code word E_{h,j} corresponding to the current data word is “110”; and the binary sum W pre-computed for the current data word is selected and output for accumulation if the code word E_{h,j} corresponding to the current data word is “111”.

After the partial sum Sₕ (h={0, . . . , H−1}) is available, the correlation value Tₕ (h={0, . . . , H−1}) can be computed using the above formula (4) or (6), depending upon actual design considerations.

For each data block, computation of binary sums and selection of one of the binary sums in the accumulation-based circuit 502 may be summarized by the following table.

TABLE 2

| E | e | | 7-to-1 DeMux Output |
|---|---|---|---|
| (binary) | (decimal) | Value of Wₑ | controlled by E |
| 000 | 0 | Not Available | Don't integrate |
| 001 | 1 | Rₙ₋₂ | W₁ |
| 010 | 2 | Rₙ₋₁ | W₂ |
| 011 | 3 | Rₙ₋₁ + Rₙ₋₂ | W₃ |
| 100 | 4 | Rₙ | W₄ |
| 101 | 5 | Rₙ + Rₙ₋₂ | W₅ |
| 110 | 6 | Rₙ + Rₙ₋₁ | W₆ |
| 111 | 7 | Rₙ + Rₙ₋₁ + Rₙ₋₂ | W₇ |

One binary sum is computed once and may be shared by computation of multiple partial sums for different hypothesis correlations. For example, assuming that the code word in the composite code sequence D_{1,n} and the code word in the composite code sequence D_{H-1,n} have the same code bits “110”, the pre-computed binary sum W_{j,6} is selected and involved in computation of the partial sum S₁, and is also selected and involved in computation of the partial sum S_{H-1}. In this way, the computation complexity of the partial sums S₀-S_{H-1} can be further reduced by reusing the pre-computed binary sums.

The performance comparison between different correlation schemes is illustrated in the following table.

TABLE 3

| | Number of PRNs to Combine | | | |
|---|---|---|---|---|
| | 2 | 3 | 4 | 5 |
| | Average SNR (dB) | | | |
| 1. Single PRN Correlation (S) | 28.4 | 28.4 | 28.4 | 28.4 |
| 2. Sum Code Correlation (A) | 25.3 | 23.5 | 22.2 | 21.1 |
| Combining Loss (A − S) | −3.1 | −4.9 | −6.2 | −7.2 |
| 3. Ternary Code Correlation (T) | 25.3 | 22.3 | 21.7 | 20.1 |
| Code Loss (T − A) | 0.0 | −1.2 | −0.4 | −1.0 |
| Zero Operation | 50% | 75% | 37% | 62% |
| 4. Binary Code Correlation (B) | — | 22.2 | — | 20.0 |
| Code Loss (B − A) | — | −1.2 | — | −1.1 |
| Zero Operation | Bypass correlation | | | |
| Chip Correlator | — | 51% | — | 51% |
| Word Correlator | (D − 1)/D + 1/(D * 2\hat{ }D), | | | |
| | D chips per word | | | |
| D = 2 | 2 | 63% | | 63% |
| D = 3 | 3 | 71% | | 71% |
| D = 5 | 5 | 81% | | 81% |

With regard to searching PRN codes of several satellite signals at the same time, when compared to a sum code correlation scheme, the proposed ternary code correlation scheme or binary code correlation can effectively reduce the computation complexity at the expense of a slight signal-to-noise ratio (SNR) loss.

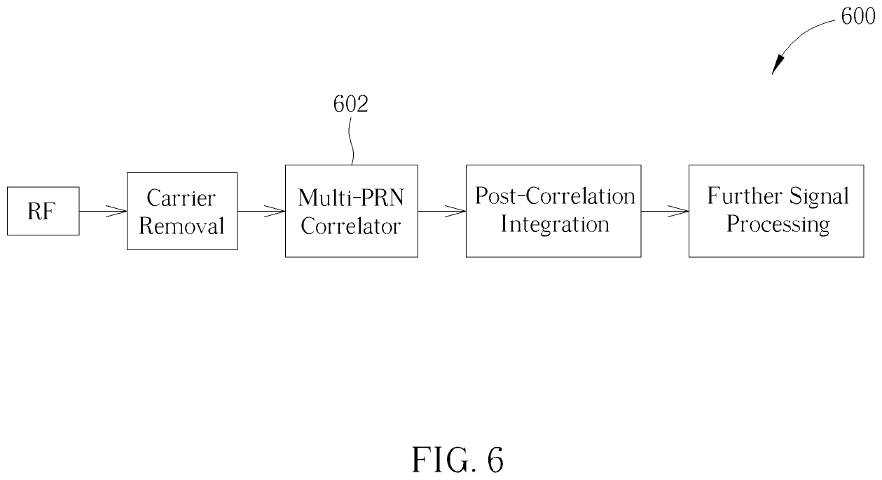

The correlation computation apparatus 100 may be a part of a multi-satellite correlator in a GNSS receiver. FIG. 6 is a diagram illustrating a first GNSS receiver architecture according to an embodiment of the present invention. The GNSS receiver 600 supports a plurality of signal processing stages, including a multi-PRN correlator 602 that employs the proposed correlation computation apparatus 100. The carrier removal stage is used to remove the carrier frequency. The multi-PRN correlator 602 is used to search timing of multiple PRN code sequences at the same time. With the help of the proposed correlation computation apparatus 100, the multi-PRN correlator 602 can perform correlation computation with reduced computation complexity. The post-correlation integration stage is used to perform more integration (coherent combining, non-coherent combining or differential combining) to enhance SNR of the correlation value. The further signal processing stage is used to detect PRN timing and Doppler shift of each satellite signal.

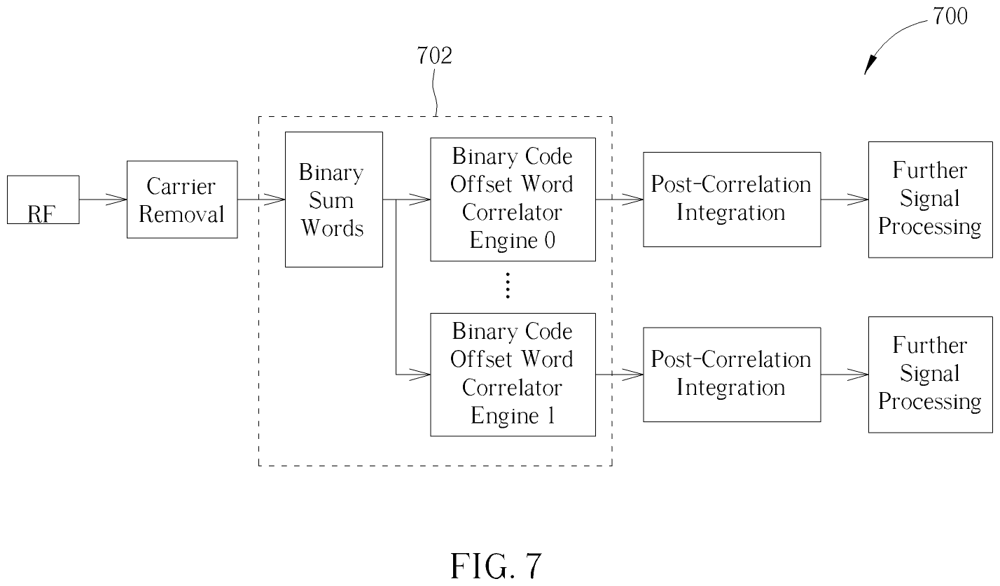

FIG. 7 is a diagram illustrating a second GNSS receiver architecture according to an embodiment of the present invention. The GNSS receiver 700 supports a plurality of signal processing stages, including a multi-PRN correlator 702 that employs the proposed correlation computation apparatus 100. More specifically, the correlation circuit 104 of the correlation computation apparatus 100 may be implemented by the correlation circuit 500 shown in FIG. where data samples of the data sequence are grouped into a plurality of data words, and each of the binary code offset word correlator engines can share binary sums pre-computed for each data word.

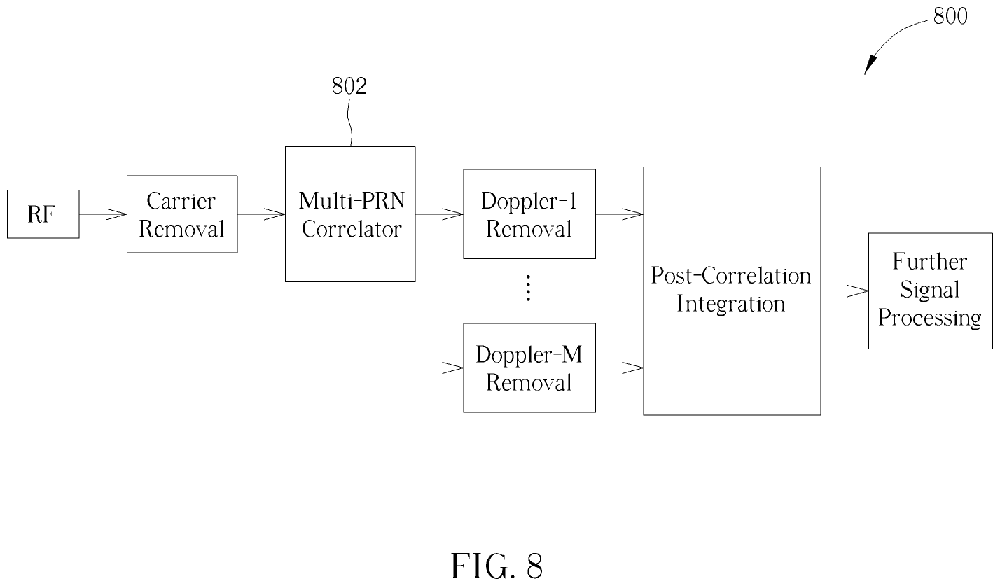

FIG. 8 is a diagram illustrating a third GNSS receiver architecture according to an embodiment of the present invention. The GNSS receiver 800 supports a plurality of signal processing stages, including a multi-PRN correlator 802 that employs the proposed correlation computation apparatus 100. The output of the multi-PRN correlator 802 can be processed by multiple Doppler removal stages that are designed for removing different Doppler frequencies to detect Doppler frequencies of the satellite signals.

It should be noted that the GNSS receiver architectures shown in FIGS. 6-8 are for illustrative purposes only, and are not meant to be limitations of the present invention. In practice, any GNSS receiver having a multi-PRN correlator that is implemented using the proposed correlation computation method and apparatus falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A correlation computation method comprising:
obtaining a plurality of code sequences;
performing, by a transformation circuit, a bit-wise combination with transformation upon the plurality of code sequences to generate a composite code sequence; and
generating a correlation value between a data sequence and the composite code sequence.

2. The correlation computation method of claim 1, wherein each of the plurality of code sequences comprises a plurality of code bits at a plurality of bit positions, respectively; and performing the bit-wise combination with transformation upon the plurality of code sequences to generate the composite code sequence comprises:
obtaining a first composite code bit from a sum of a plurality of first code bits at a first bit position in the plurality of the code sequences; and
applying a predetermined transformation to the first composite code bit, for generating a first code bit at the first bit position in the composite code sequence.

3. The correlation computation method of claim. 2, wherein performing the bit-wise combination with transformation upon the plurality of code sequences to generate the composite code sequence further comprises:
obtaining a second composite code bit from a sum of a plurality of second code bits at a second bit position in the plurality of the code sequences, wherein the second bit position is different from the first bit position; and
applying the predetermined transformation to the second composite code bit, for generating a second code bit at the second bit position in the composite code sequence;
wherein the first composite code bit and the second composite code bit have different values, and the first code bit and the second code bit included in the composite code sequence have a same value.

4. The correlation computation method of claim 1, wherein generating the correlation value between the data sequence and the composite code sequence comprises:
in response to a specific code bit in the composite code sequence having a zero value, skipping correlation between the specific code bit and a specific data sample included in the data sequence that is paired with the specific code bit.

5. The correlation computation method of claim 1, wherein the bit-wise combination with transformation employs ternary code transformation or binary code transformation.

6. The correlation computation method of claim 1, wherein generating the correlation value between the data sequence and the composite code sequence comprises:
obtaining a first sum of all data samples included in the data sequence;
obtaining a second sum of selected data samples that are selected from the data sequence according to code bits included in the composite code sequence; and
deriving the correlation value between the data sequence and the composite code sequence from the first sum and the second sum.

7. The correlation computation method of claim 6, wherein deriving the correlation value between the data sequence and the composite code sequence from the first sum and the second sum comprises:
obtaining a multiplication result from multiplying the second sum by a predetermined factor; and
generating the correlation value by subtracting the multiplication result from the first sum.

8. The correlation computation method of claim 6, wherein deriving the correlation value between the data sequence and the composite code sequence from the first sum and the second sum comprises:
obtaining a division result from dividing the first sum by a predetermined factor; and
generating the correlation value by subtracting the second sum from the division result.

9. The correlation computation method of claim 6, wherein the composite code sequence is a binary code sequence.

10. The correlation computation method of claim 1, wherein the correlation computation method is employed by a multi-satellite correlator in a global navigation satellite system (GNSS) receiver.

11. A correlation computation apparatus comprising:
a transformation circuit, arranged to obtain a plurality of code sequences, and perform a bit-wise combination with transformation upon the plurality of code sequences to generate a composite code sequence; and
a correlation circuit, arranged to generate a correlation value between a data sequence and the composite code sequence.

12. The correlation computation apparatus of claim 11, wherein each of the plurality of code sequences comprises a plurality of code bits at a plurality of bit positions, respectively; and the transformation circuit is arranged to obtain a first composite code bit from a sum of a plurality of first code bits at a first bit position in the plurality of the code sequences, and apply a predetermined transformation to the first composite code bit for generating a first code bit at the first bit position in the composite code sequence.

13. The correlation computation apparatus of claim 12, wherein the transformation circuit is further arranged to obtain a second composite code bit from a sum of a plurality of second code bits at a second bit position in the plurality of the code sequences, and apply the predetermined transformation to the second composite code bit for generating a second code bit at the second bit position in the composite code sequence, where the second bit position is different from the first bit position, the first composite code bit and the second composite code bit have different values, and the first code bit and the second code bit included in the composite code sequence have a same value.

14. The correlation computation apparatus of claim 11, wherein when a specific code bit in the composite code sequence has a zero value, the correlation circuit is arranged to skip correlation between the specific code bit and a specific data sample included in the data sequence that is paired with the specific code bit.

15. The correlation computation apparatus of claim 11, wherein the bit-wise combination with transformation employs ternary code transformation or binary code transformation.

16. The correlation computation apparatus of claim 11, wherein the correlation circuit comprises:
an accumulation-based circuit, arranged to obtain a first sum of all data samples included in the data sequence, and obtain a second sum of selected data samples that are selected from the data sequence according to code bits included in the composite code sequence; and
a processing circuit, arranged to derive the correlation value between the data sequence and the composite code sequence from the first sum and the second sum.

17. The correlation computation apparatus of claim 16, wherein the processing circuit is arranged to obtain a multiplication result from multiplying the second sum by a predetermined factor, and generate the correlation value by subtracting the multiplication result from the first sum.

18. The correlation computation apparatus of claim 16, wherein the processing circuit is arranged to obtain a division result from dividing the first sum by a predetermined factor, and generate the correlation value by subtracting the second sum from the division result.

19. The correlation computation apparatus of claim 16, wherein the composite code sequence is a binary code sequence.

20. The correlation computation apparatus of claim 11, wherein the correlation computation apparatus is a part of a multi-satellite correlator in a global navigation satellite system (GNSS) receiver.
